(19) United States
(12) Patent Application Publication
(10) Pub. No.: US 2017/0316311 A1
(43) Pub. Date: Nov. 2, 2017

(54) SPARSE INFERENCE MODULES FOR DEEP LEARNING

(71) Applicant: HRL Laboratories, LLC, Malibu, CA (US)

(72) Inventors: Praveen K. Pilly, West Hills, CA (US); Nigel D. Stepp, Santa Monica, CA (US); Narayan Srinivasa, Oak Park, CA (US)

(21) Appl. No.: 15/079,899

(22) Filed: Mar. 24, 2016

Related U.S. Application Data
(60) Provisional application No. 62/137,665, filed on Mar. 24, 2015.
(60) Provisional application No. 62/155,355, filed on Apr. 30, 2015.

(51) Int. Cl. G06N 3/08; G06N 5/04

(52) U.S. Cl. CPC G06N 3/08; G06N 5/04

(57) ABSTRACT

Described is a sparse inference module that can be incorporated into a deep learning system. For example, the deep learning system includes a plurality of hierarchical feature channel layers, each feature channel layer having a set of filters. A plurality of sparse inference modules can be included such that a sparse inference module resides electronically within each feature channel layer. Each sparse inference module is configured to receive data and match the data against a plurality of pattern templates to generate a degree of match value for each of the pattern templates, with the degree of match values being sparsified such that only those degree of match values that exceed a predetermined threshold, or a fixed number of the top degree of match values, are provided to subsequent feature channels in the plurality of hierarchical feature channels, while other, losing degree of match values are quenched to zero.

### CROSS-REFERENCE TO RELATED APPLICATIONS

This is a non-provisional patent application of U.S. Provisional Application No. 62/137,665, filed Mar. 24, 2015, the entirety of which is hereby incorporated by reference.

This is ALSO a non-provisional patent application of U.S. Provisional Application No. 62/155,355, filed Apr. 30, 2015, the entirety of which is hereby incorporated by reference.

### GOVERNMENT RIGHTS

This invention was made with government support under U.S. Government Contract Number UPSIDE. The government has certain rights in the invention.

### BACKGROUND OF INVENTION

### (1) Field of Invention

The present invention generally relates to a recognition system and, more particularly, to modules that can be used in a multi-dimensional signal processing pipeline to recognize signal classes by adaptively extracting information using multiple hierarchical feature channels.

### (2) Description of Related Art

Deep learning is a branch of machine learning that attempts to model high-level abstractions in data by using multiple processing layers with complex structures. Deep learning can be implemented for signal recognition. Examples of such deep learning methods include the convolution network (see the List of Incorporated Literature References, Literature Reference No. 1), the HMAX model (see Literature Reference No. 2), and hierarchy of auto-encoders. The key disadvantage of these methods is that they require high numerical precision to store the innumerable weights and to process the innumerable cell activities. This is the case because at low precision the weight updates in both incremental and batch learning modes are not likely registered, being relatively small compared to the interval between the quantization levels for the weights. Fundamentally, deep learning methods require a minimum number to bits to adapt the weights and achieve reasonable recognition performance. Nevertheless, even this minimum number of bits can be prohibitive to meet high energy and throughput challenges when the depth of the pipeline increases and as the input size increases. Thus, a challenge is to learn the weights at low precision, while the cell activities are represented and processed at low precision.

A well-known technique to deal with the issue of registering small weight updates with fewer bits in multi-layer processing architectures is the probabilistic rounding method (see Literature Reference No. 3). In the probabilistic rounding method, each weight change (as computed by any supervised or unsupervised method) is first rectified and scaled by the interval between quantization levels for the weights, and then compared with a uniform random number between 0 and 1. If the random number is relatively smaller, the particular weight is updated to the neighboring quantization level in the direction of the initial weight change. Although capable of dealing with small weight updates, even this method requires at least 5-10 bits depending on the dataset, allowing for “gradual degradation in performance as precision is reduced to 6 bits”.

Thus, a continuing need exists for a system that achieves high recognition performance for multi-dimensional signal processing pipelines despite low-precision weights and activities.

### SUMMARY OF INVENTION

Described is a sparse inference module for deep learning. In various embodiments the sparse inference module includes one or more processors and a memory. The memory has executable instructions encoded thereon, such that upon execution, the one or more processors perform several operations, such as receiving data and matching the data against a plurality of pattern templates to generate a degree of match value for each of the pattern templates; sparsifying the degree of match values such that only those degree of match values that satisfy a criterion are provided for further processing as sparse feature vectors, while other losing degree of match values are quenched to zero; and using the sparse feature vectors to self-select a channel that participates in high-level classification.

In another aspect, the data comprises at least one of still image information, video information, and audio information.

In yet another aspect, self-selection of the channel facilitates classification of at east one of still image information, video information, and audio information.

Additionally, the criterion requires the degree of match value to be above a threshold limit.

In another aspect, the criterion requires the degree of match value to be within a fixed quantity of the top degree of match values.

In another aspect, described is a deep learning system using sparse learning modules. In this aspect, the deep learning system comprises a plurality of hierarchical feature channel layers, each feature channel layer having a set of filters that filter data received in the feature channel; a plurality of sparse inference modules, where a sparse inference module resides electronically within each feature channel layer; and wherein one or more of the sparse inference module is configured receive data and match the data against a plurality of pattern templates to generate a degree of match value for each of the pattern templates, and sparsify the degree of match values such that only those degree of match values that satisfy a criterion are provided for further processing as sparse feature vectors, while other losing degree of match values are quenched to zero, and use the sparse feature vectors to self-select a channel that participates in high-level classification.

Additionally, the deep learning system is a convolution neural network (CNN) and the plurality of hierarchical feature channel layers include a first matching layer and a second matching layer. The deep learning system also comprises a first pooling layer electronically positioned between the first and second matching layers; and a second pooling layer, the second pooling layer positioned downstream from the second matching layer.

In another aspect, the first feature matching layer includes a set of filters, a compressive nonlinearity module, and a sparse inference module. The second feature matching layer includes a set of filters, a compressive nonlinearity module, and a sparse inference module. The first pooling layer includes a pooling module and a sparse inference module and the second pooling layer includes a pooling module and a sparse inference module.

In another aspect, the sparse learning modules further operate across spatial locations in each of the feature channel layers.

Finally, the present invention also includes a computer program product and a computer implemented method. The computer program product includes computer-readable instructions stored on a non-transitory computer-readable medium that are executable by a computer having one or more processors, such that upon execution of the instructions, the one or more processors perform the operations listed herein. Alternatively, the computer implemented method includes an act of causing a computer to execute such instructions and perform the resulting operations.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The objects, features and advantages of the present invention will be apparent from the following detailed descriptions of the various aspects of the invention in conjunction with reference to the following drawings, where:

FIG. 1 is a block diagram depicting the, components, of a system according to various embodiments of the present invention;

FIG. 2 is an illustration of a computer program product embodying an aspect of the present invention;

FIG. 3 is a flow chart depicting a sparse inference module in operation;

FIG. 4 is an illustration depicting a sparsification process within a sparse inference module, by which a top subset of degree-of-match values survive being cut;

FIG. 5 is an illustration of a block diagram, depicting an illustrative pipeline for convolution neural network (CNN)-based recognition system, from an image chip (IL) to a category layer (CL);

FIG. 6 is an illustration depicting application of sparse inference modules to each layer of a conventional CNN (as depicted in FIG. 5);

FIG. 7 is an illustration depicting how sparse inference modules, through regular supervised training, automatically down-select the number of useful feature channels in each layer of the depicted CNN; and

FIG. 8 is a chart depicting performance of probabilistic rounding combined with the sparse inference modules.

### DETAILED DESCRIPTION

The present invention generally relates to a recognition system and, more particularly, to modules that can be used in a multi-dimensional signal processing pipeline to recognize signal classes by adaptively extracting information using multiple hierarchical feature channels. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of aspects. Thus, the present invention is not intended to be limited to the aspects presented, but is to be accorded the widest scope consistent with the principles and novel features disclosed herein.

In the following detailed description, numerous specific details are set forth in order to provide a more thorough understanding of the present invention. However, it will he apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Before describing the invention in detail, first a list of cited references is provided. Next, a description of the various principal aspects of the present invention is provided. Subsequently, an introduction provides the reader with a general understanding of the present invention. Finally, specific details of various embodiment of the present invention are provided to give an understanding of the specific aspects.

### (1) LIST OF CITED LITERATURE REFERENCES

The following references are cited throughout this application. For clarity and convenience, the references are listed herein as a central resource for the reader. The following references are hereby incorporated by reference as though fully set forth herein. The references are cited in the application by referring to the corresponding literature reference number,
1. Pierre Sermanet, David Eigen, Xiang Ziang, Michael Mathieu, Rob Fergus and Yann LeCun: OverFeat: Integrated Recognition, Localization and Detection using Convolutional Networks, International Conference on Learning Representations (ICLR2014), CBLS.
2. Serre, T., Oliva, A., & Poggio, T. (2007). A feedforward architecture accounts for rapid categorization. Proceedings of the National Academy of Sciences, 104(15), 6424-6429.
3. Hoehfeld, M., & Fahlman, S. E. (1992). Learning with Limited Numerical Precision Using the Cascade-Correlation Learning Algorithm. IEEE Transactions on Neural Networks, 3(4), 602-611.
4. R. Kasturi, D. Goldgof, P. Soundararajan, V. Manohar, J. Garofolo, R. Bowers, M. Boonstra, V. Korzhova, and J. Zhang, “Framework for Performance Evaluation of Face, Text, and Vehicle Detection and Tracking in Video: Data, Metrics, and Protocol,” IEEE TPAMI Vol. 31, 2009.

(2) Principal Aspects

Various embodiments of the invention include three “principal” aspects. The first is a system having sparse inference modules that can be used in a multi-dimensional signal processing pipeline to recognize signal classes by adaptively extracting information using multiple hierarchical feature channels. The system is typically in the form of a computer system operating software or in the form of a “hard-coded” instruction set. This system may be incorporated into a wide variety of devices that provide different functionalities. The second principal aspect is a method, typically in the form of software, operated using a data processing system (computer). The third principal aspect is a computer program product. The computer program product generally represents computer-readable instructions stored on a non-transitory computer-readable medium such as an optical storage device, e.g., a compact disc (CD) or digital versatile disc (DVD), or a magnetic storage device such as a floppy disk or magnetic tape. Other, non-limiting examples of computer-readable media include hard disks, read-only memory (ROM), and flash-type memories. These aspects will be described in more detail below.

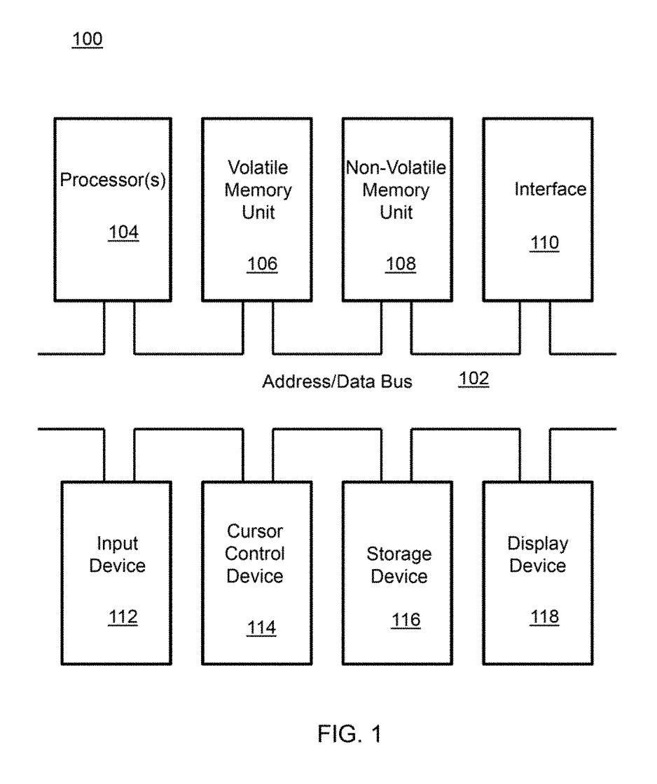

A block diagram depicting an example of a system (i.e., computer system 100) of the present invention is provided in FIG. 1. The computer system 100 is configured to perform calculations, processes, operations, and/or functions associated with a program or algorithm. In one aspect, certain processes and steps discussed herein are realized as a series of instructions (e.g., software program) that reside within computer readable memory units and are executed by one or more processors of the computer system 100. When executed, the instructions cause the computer system 100 to perform specific actions and exhibit specific behavior, such as described herein.

The computer system 100 may include an address/data bus 102 that is configured to communicate information. Additionally, one or more data processing units, such as a processor 104 (or processors), are coupled with the address/data bus 102. The processor 104 is configured to process information and instructions. In an aspect, the processor 104 is a microprocessor. Alternatively, the processor 104 may be a different type of processor such as a parallel processor, or a field programmable gate array.

The computer system 100 is configured to utilize one or more data storage units. The computer system 100 may include a volatile memory unit 106 (e.g., random access memory (“RAM”), static RAM, dynamic RAM, etc.) coupled with the address/data bus 102, wherein a volatile memory unit 106 is configured to store information and instructions for the processor 104. The computer system 100 further may include a non-volatile memory unit 108 (e.g., read-only memory (“ROM”), programmable ROM (“PROM”), erasable programmable ROM (“EPROM”), electrically erasable programmable ROM “EEPROM”), flash memory, etc.) coupled with the address/data bus 102, wherein, the non-volatile memory unit 108 is configured to store static information and instructions for the processor 104. Alternatively, the computer system 100 may execute instructions retrieved from an online data storage unit such as in “Cloud” computing. In an aspect, the computer system 100 also may include one or more interfaces, such as an interface 110, coupled with the address/data bus 102. The one or more interfaces are configured to enable the computer system 100 to interface with other electronic devices and computer systems. The communication interfaces implemented by the one or more interfaces may include wireline (e.g., serial cables, modems, network adaptors, etc.) and/or wireless (e.g., wireless modems, wireless network adaptors, etc.) communication technology.

In one aspect, the computer system 100 may include an input device 112 coupled with the address/data bus 102, wherein the input device 112 is configured to communicate information and command selections to the processor 100. In accordance with one aspect, the input device 112 is an alphanumeric input device, such as a keyboard, that may include alphanumeric and/or function keys. Alternatively, the input device 112 may be an input device other than an alphanumeric input device, such as sensors or other device(s) for capturing signals, or in yet another aspect, the input device 112 may be another module in a recognition system pipeline. In an aspect, the computer system 100 may include a cursor control device 114 coupled with the address/data bus 102, wherein the cursor control device 114 is configured to communicate user input information and/or command selections to the processor 100. In an aspect, the cursor control device 114 is implemented using a device such as a mouse, a track-ball, a track-pad, an optical tracking device, or a touch screen. The foregoing notwithstanding, in an aspect, the cursor control device 114 is directed and/or activated via input from the input device 112, such as in response to the use of special keys and key sequence commands associated with the input device 112. In an alternative aspect, the cursor control device 114 is configured to be directed or guided by voice commands.

In an aspect, the computer system 100 further may include one or more optional computer usable data storage devices, such as a storage device 116, coupled with the address/data bus 102. The storage device 116 is configured to store information and/or computer executable instructions. In one aspect, the storage device 116 is a storage device such as a magnetic or optical disk drive (e.g., hard disk drive (“HDD”), floppy diskette, compact disk read only memory (“CD-ROM”), digital versatile disk (“DVD”)). Pursuant to one aspect, a display device 118 is coupled with the address/data bus 102, wherein the display device 118 is configured to display video and/or graphics. In an aspect, the display device 118 may include a cathode ray tube (“CRT”), liquid crystal display (“LCD”), field emission display (“FED”), plasma display, or any other display device suitable for displaying video and/or graphic images and alphanumeric characters recognizable to a user.

The computer system 100 presented herein is an example computing environment in accordance with an aspect. However, the non-limiting example of the computer system 100 is not strictly limited to being a computer system. For example, an aspect provides that the computer system 100 represents a type of data processing analysis that may be used in accordance with various aspects described herein. Moreover, other computing systems may also be implemented. Indeed, the spirit and scope of the present technology is not limited to any single data processing environment. Thus, in an aspect, one or more operations of various aspects of the present technology are controlled or implemented using computer-executable instructions, such as program modules, being executed by a computer. In one implementation, such program modules include routines, programs, objects, components and/or data structures that are configured to perform particular tasks or implement particular abstract data types. In addition, an aspect provides that one or more aspects of the present technology are implemented by utilizing one or more distributed computing environments, such as where tasks are performed by remote processing devices that are linked through a communications network, or such as where various program modules are located in both local and remote computer-storage media including memory-storage devices.

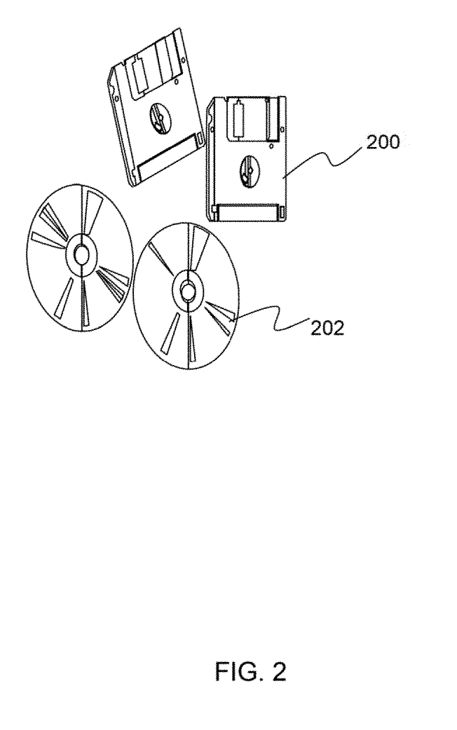

An illustrative diagram of a computer program product (i.e., storage device) embodying the present invention is depicted in FIG. 2. The computer program product is depicted as floppy disk 200 or an optical disk 202 such as a CD or DVD. However, as mentioned previously, the computer program product generally represents computer-readable instructions stored on any compatible non-transitory computer-readable medium. The term “instructions” as used with respect to this invention generally indicates a set of operations to be performed on a computer, and may represent pieces of a whole program or individual, separable, software modules. Non-limiting examples of “instruction” include computer program code (source or object code) and “hard-coded” electronics (i.e. computer operations coded into a computer chip). The “instruction” is stored on any non-transitory computer-readable medium, such as in the memory of a computer or on a floppy disk, a CD-ROM, and a flash drive. In either event, the instructions are encoded on a non-transitory computer-readable medium.

(3) Introduction

This disclosure provides a unique system and, method that uses sparse inference modules to achieve high recognition performance for multi-dimensional signal processing pipelines despite low-precision weights and activities. The system is applicable to any deep learning architecture that operates on arbitrary signal patterns (e.g., audio, image, video) to recognize their classes by adaptively extracting information using multiple hierarchical feature channels. The system operates on both feature matching and pooling layers in deep learning networks (e.g., convolutional neural network, HMAX model) by a competitive process that generates a sparse feature vector for various subsets of input data at each layer in the processing hierarchy using the principle of k-WTA (winner take all). This principle is inspired by local circuits in the brain, where neurons tuned to respond to different patterns in the incoming signals from an upstream region inhibit each other using interneurons such that only the ones that are maximally activated survive the quenching threshold. This process of sparsification also enables probabilistic learning with reduced precision weights, thereby making pattern recognition amenable for energy-efficient hardware implementations.

The system serves two key goals: (a) identify a subset of feature channels that are sufficient and necessary to process a given dataset for pattern recognition, and (b) ensure optimal recognition performance for the situations in which the weights of connections between nodes in the networks and the node activities themselves can only be represented and processed at low numerical precision. These two goals play a critical role for practical realizations of deep learning architectures, which are the current state of the art, because of the enormous processing and memory requirements to implement a very deep network of processing layers that are typically required to solve complex pattern recognition problems for reasonably-sized input streams. For instance, the well-known OverFeat architecture (see Literature Reference No. 1) uses 11 layers (8 feature matching, and 3 MAX pooling), with the number of channels ranging from 96 to 1024 at different layers, to recognize among 1000 object classes in response to input images sized at 231×231. More numerical precision leads to more size, weight, area, and power requirements, which are prohibitive for practical real-world deployment of these state-of-the-art deep learning engines on moving and flying platforms such as mobile phones, autonomous navigating robots, and unmanned aerial vehicles (UAVs).

The sparse inference modules can also benefit stationary applications such as surveillance cameras, because it suggests a general method to build ultra-low power and high throughput recognition systems. The system can also be used in numerous automotive and aerospace applications, including cars, planes, and UAVs, where pattern recognition plays a key role. For example, the system can be used for (a) identifying both stationary and moving objects on the road for autonomous cars, and (b) recognizing prognostic patterns in large volumes of real-time data from aircrafts for intelligent scheduling of maintenance or other matters. Specific details of the system and its sparse inference modules are provided below.

### Specific Details of Various Embodiments

As noted above, this disclosure provides a system and method that uses sparse inference modules to achieve high recognition performance for multi-dimensional signal processing pipelines. The system operates on deep learning architectures that comprise multiple feature channels to sparsity feature vectors (e.g., degree of match values) at each layer in the hierarchy. In other words, the feature vectors are “sparsified” at each layer in the hierarchy, meaning that only those values that satisfy a criteria (“winners”) are allowed to proceed as sparse feature vectors, while other, losing values, are quenched to zero. As a non-limiting example, the criteria includes a fixed number of values such as the top 10%, etc., or those exceeding a value (which can be determined adaptively).

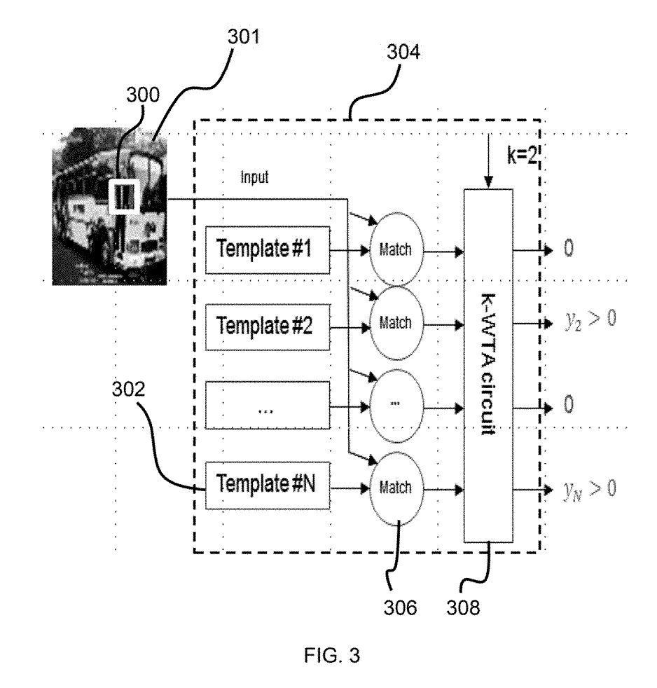

For example and as shown in FIG. 3, data, such as that in the receptive field 300 within the image chip 301, is matched with multiple pattern templates 302 in the sparse inference module 304 to determine a degree of match between a particular pattern template 302 the data in the receptive field 300. The resultant degree-of-match values 306 are sparsified 308 such that only a subset of the values (k=2 in this example) that satisfy a criteria (e.g., are maximal) are passed onto the next stage. The degree-of-match can be determined using any suitable technique. As a non-limiting example, the degree-of-match can be determined using a convolution (or dot product). Another example includes oscillator synchronization and the process as described in U.S. patent application Ser. No. 14/202,200, filed Mar. 10, 2014 and titled “Method to perform convolutions between arbitrary vectors using weakly coupled oscillator clusters,” the entirety of which is incorporated herein by reference.

Deep learning networks comprise cascading stages of feature matching and pooling layers to generate a high-level multi-channel representation that is conducive for simple, linearly separable categorization into various classes. Cells in each feature matching layer infer the degree of match between different learned patterns (based on feature channels) and activities in the upstream layer within their localized receptive fields.

The method of sparse inference modules, which should be applied during both training and testing, introduces explicit competition throughout the pipeline within each of the various sets of cells across the feature channels that share a spatial receptive field. Within each such set of cells with a same spatial receptive field, this operation ensures that only a given fraction of cells with maximal activities (such as the top 10% or any other predetermined amount, or those cells having values exceeding a predetermined threshold) are able to propagate their signals to the next layer in the deep learning network. Output activities of non-selected cells are quenched to zero.

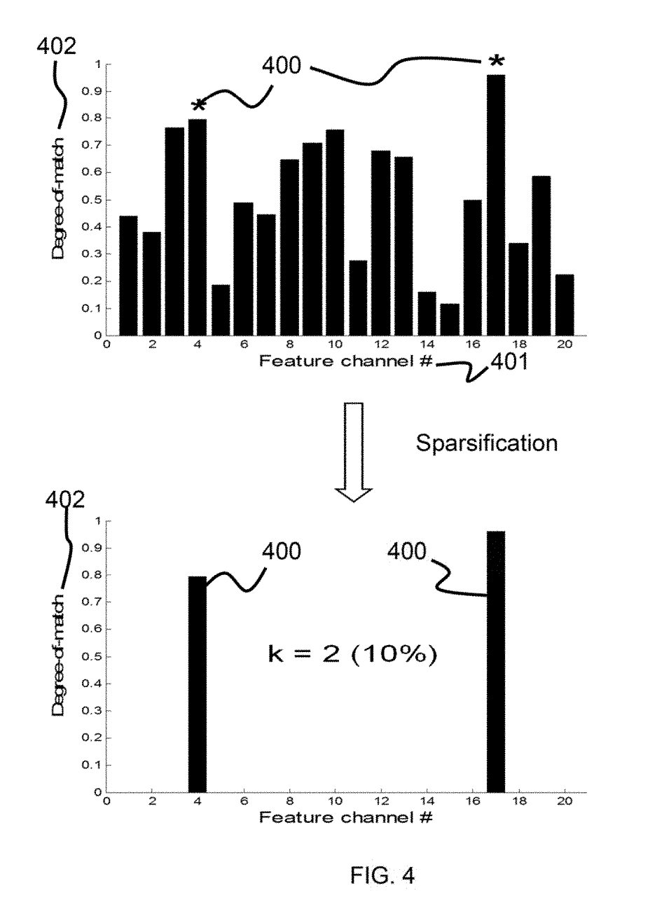

FIG. 4 provides another illustration of how this method works. When the method is applied across space and at each layer in a deep learning architecture, sparse distributed representations (e.g., feature channels) 401 are created by which a top subset 400 of degree-of-match values 402 survive being cut. For a visual stimulus this is in line with the premise that at each spatial location there are at most a handful features that can be present unambiguously; i.e., the various feature detectors at each location compete among themselves such that a suitable stimulus representation is achieved across space.

Sparse inference modules at each layer in deep learning networks are critical when probabilistic rounding is applied at low numerical precision for weights, because it restricts the weight updates to only those projections whose input and output neurons have “signal” activities, which have not been quenched to zero. In the case without sparsification, weights do not stabilize towards minimizing the least squares at the final categorization layer because of “noisy” jumps from one quantization level to the other in almost all projections. Thus, the system and method is not only useful for reducing the energy consumption of any deep learning pipeline, but also is critical for any learning to happen in the first place when weights are to be learned and stored only at low precision.

(4.1) Specific Example Implementations

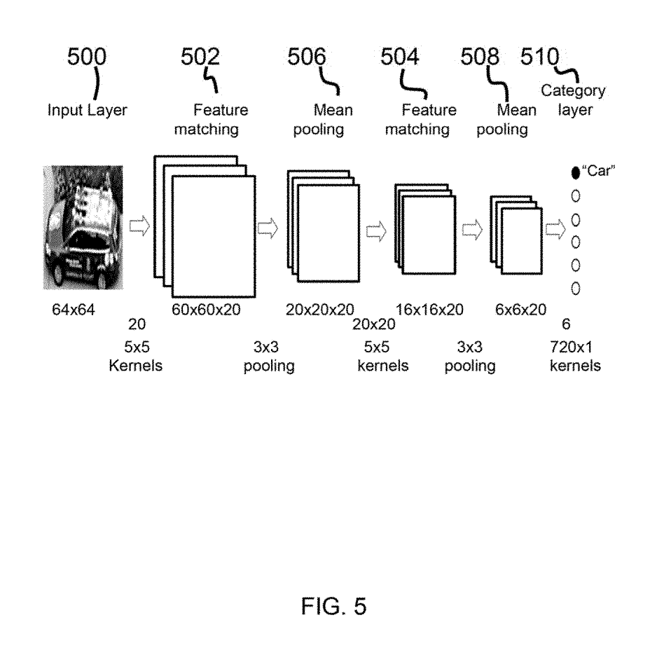

The sparse inference modules can be applied to, for example, a convolution neural network (CNN) to demonstrate the benefit of unimpaired recognition ability despite low numerical precision (<6 bits) for the weights throughout the pipeline. FIG. 5 depicts an example CNN that includes an input layer 500 (i.e., image patch) of size 64×64 pixels (or any other suitable size), which in this example registers the grayscale image of an image chip; two cascading stages of alternating feature matching layers (502, 504) and pooling layers (506, 508) with 20 feature channels each; and an output category layer 510 of 6 category cells. In this example, the first feature matching layer 502 includes twenty 60×60 pixel maps, the first pooling layer 506 includes twenty 20×20 pixel maps, the second feature matching layer 504 includes twenty 16×16 pixel maps, and the second pooling layer 508 includes twenty 6×6 pixel maps. Each map in the second feature matching layer 504 receives inputs from all feature channels in the first pooling layer 506. Both pooling layers 506 and 508 subsample their input matching layers (i.e., 502 and 504, respectively) by calculating mean values over 3×3 pixel non-overlapping spatial windows in each of the 20 maps. The sigmoidal non-linearity between the matching layers 502 and 504 and pooling layers 506 and 508 helps to globally suppress noise and also place bounds on cell activities.

In other words, the CNN receives an image patch as the input layer 500. In the first feature matching, layer 502, the image patch is convolved with a set of filters to generate a corresponding set of feature maps. Each filter also has an associated bias term, and the convolution outputs are typically passed through a compressive nonlinearity module, such as a sigmoid. “Kernels” refers to the filters used in the convolution step. In this example, 5×5 pixels is the size of each kernel in first feature matching layer 502 (in this particular implementation). The resulting convolution output is provided to the first pooling layer 506, which downsamples the convolution output using mean pooling (i.e., a pooling module where a block of pixels in the input is averaged to produce a single pixel in the output). In this example, 3×3 pixels is the size of the neighborhood used for meaning (9 pixels in total, for this particular implementation). This happens within each feature channel. The first pooling layer 506 outputs are received in the second feature matching layer 504, where they are convolved with a set of filters that operate across feature channels to generate a corresponding set of higher-level feature maps. As in the first feature matching layer 502, each set of filters have an associated bias term, and the convolution outputs are passed through a compressive nonlinearity module, such as a sigmoid. The second pooling layer 508 then performs the same operations as the first pooling layer 506; however, this operation happens within each feature channel (unlike the second feature matching layer 504). The category layer 510 maps the pooling layered output from the second pooling layer 508 to neurons (e.g., six neurons) coding for various classes. In other words, the category layer 510 has one output neuron for each recognition class (e.g., car, truck, bus, etc.). The category layer (e.g., classifier) 510 provides the final classification of the input in that category layer with the highest activity is taken to be the classification of the input image.

The CNN in this example was trained with error back-propagation for one epoch, which comprised 100,000 examples sampled randomly from the boxes detected by a spectral saliency-based object detection frontend for the Training sequences of the Stanford Tower dataset. The presented examples exhibited the base rates of the 6 classes (“Car”, “Truck”, “Bus”, “Person”, “Cyclist”, and “Background”) across all the sequences: 11.15%, 0.14%, 0.44%, 19.34%, 8.93%, and 60%, respectively. The trained CNN was evaluated on a representative subset of 10,000 boxes that were sampled at random from those detected by the frontend for the Stanford Tower dataset Test sequences, which roughly maintain the base, rates, of the classes under consideration. For evaluation, a metric was used called the weighted normalized multiple object thresholded detection accuracy (WNMOTDA) (see Literature Reference No. 4). The WNMOTDA score was defined as follows:
1. A normalized multiple object thresholded detection accuracy (NMOTDA) score was first computed for each of the 5 object classes (“Car”, “Truck”, “Bus”, “Person”, “Cyclist”) across all the image chips:

$$NMOTDA = 1 - \frac{{c}_{m} ( Miss \# ) + {c}_{fa} ( False Alarm \# )}{Ground Truth \#} .$$

NMOTDA penalizes misses and false alarms using the associated costs cₘ and c_{fa} (each set to a value of 1), which are normalized by the number of ground-truth instances of the class. The NMOTDA scores range from −∞to 1. They are 0 when the system does not do anything; i.e., misses all objects of a given class and has no false alarms. An object misclassification is considered a miss for the ground-truth class, but not a false alarm for the system output class. However, a “Background” image chip that is misclassified as one of the 5 object classes is counted as a false alarm.
2. A single performance score was then calculated by a weighted average of the NMOTDA scores across the 5 object classes using their normalized frequencies fi (between 0 and 1) in the test set:

WNMOTDA=Σfₛ·NMOTDAᵢ

The learned weights in feature matching layers 502 and 504 were then quantized using a precision of 4 bits, and hard-wired into a new version of the CNN called ‘non-sparse Gold CNN’.

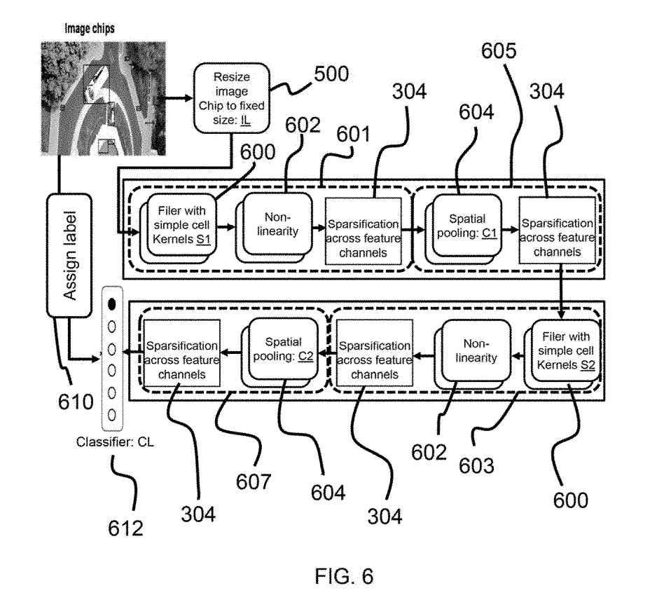

The present invention improves upon a typical CNN or other deep learning process by adding the sparsification process or sparse inference module into each of the layers described above, such that the output of each layer is a set of “activities” or numeric values that pass the sparsification process, thereby improving the resulting output from each layer. Thus, in various embodiments according to the principles of the present invention, each of the layers described above (with respect to FIG. 5) incorporates the sparse inference module 304 as depicted in FIG. 3. This is further clarified in FIG. 6, which depicts a high-level schematic of the Sparse CNN flow which incorporates the sparse inference module 304. Thus, the sparse inference modules were then applied to a conventional CNN (see FIG. 6), and were provided the same training as above with a parameter of k=10% for sparsification in each layer. In this step, the weights were still learned with double precision as the conventional CNN. While all 20 feature channels in each layer are employed for the conventional CNN, the application of sparse inference modules during training gradually self-selected a subset of the channels in each layer that exclusively participate in the high-level classification of the image chips.

For further understanding, FIG. 6 depicts a high-level schematic of the Sparse CNN flow, showing how the sparse inference module 304 is incorporated into the various layers to improve the relevant outputs. In this case, the first feature matching layer 601 includes the set of filters 600 and a subsequent compressive nonlinearity module 602 (such as a sigmoid). Uniquely, the feature matching layer 601 also includes a sparse inference module 304. Additionally, the first pooling layer 605 includes a pooling module 604 (which downsamples the convolution output using mean pooling) and a sparse inference module 304. The second feature matching layer 603 then includes a set of filers 600, a subsequent compressive nonlinearity module 602, and a sparse inference module 304. Finally, the second pooling layer 607 includes a pooling module 604 and a sparse inference module 304, with outputs provided to the category layer 612 (e.g., classifier), which can be assigned labels 610 using ground truth (GT) annotations that are used for classification. As clearly depicted in FIG. 6, the sparse inference module 304 can be incorporated into any multi-dimensional signal processing pipeline that operates on arbitrary signal patterns (e.g., audio, image, video) to recognize their classes by adaptively extracting information using multiple hierarchical feature channels.

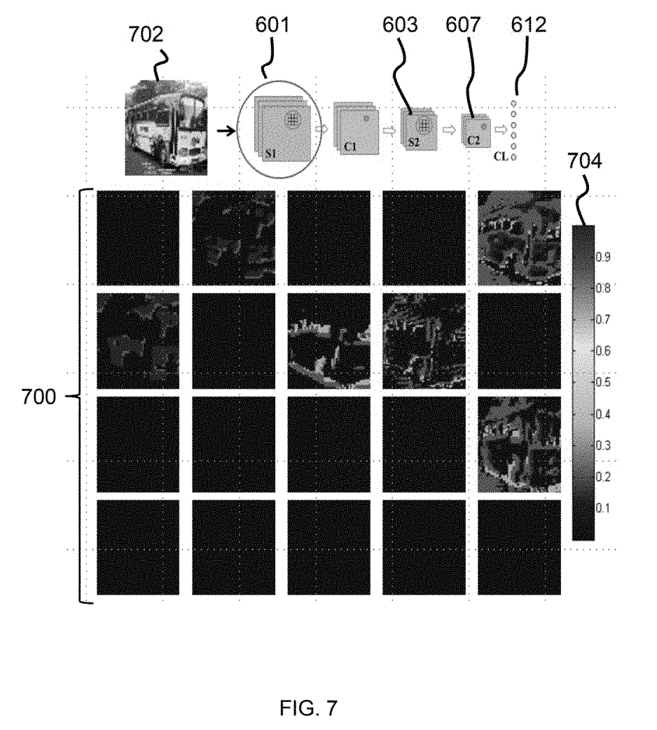

FIG. 7 highlights the property of the sparse inference modules that result in the self-selection of a subset of channels in each layer that exclusively participate in the high-level classification of the image chips. FIG. 7 illustrates this property for the first matching layer 601. Once the epoch training was completed, the weights in the first matching layer 601 and second matching layer 603 were again quantized using a precision of 4 bits, and hard-wired into another version of the CNN called just ‘Gold CNN’. Training for either ‘non-sparse Gold CNN’ or ‘Gold CNN’ comprised learning only the weights of projections from the final pooling layer 607 to the output category layer 612 at much lower than double precision. The number of bits to represent the category layer 612 weights was varied from 3 to 12 in steps of one, and probabilistic rounding was either turned ON or OFF. Cell activities throughout these new pipelines were quantized at 3 bits.

In other word, FIG. 7 depicts cell activities in 20 feature maps 700 in the first feature matching layer 601, resulting from convolution of an image with 20 different filters, in which each pixel is referred to as a cell. Each cell is a location within a feature channel. Cell activities obtained by convolving the image patch 701 with a particular feature kernel/filter results in the corresponding feature map. In other words, if there are 20 feature kernels operating on the image patch 702, one would obtain 20 feature maps 700, or activity maps in 20 feature channels. The color scale 704 depicts cell activation. In various embodiments, cell activation is the result of a convolution, adding a bias term, the application of a nonlinearity, and sparsification across feature channels at each location in a given layer. Cell activations go on to be inputs to subsequent layers.

It should be noted that in this example, 20 feature channels are selected. However, the number of selected channels is an arbitrary choice based on the number of desired features. Another outcome of employing inference modules is to automatically prune down the number of feature channels at each stage without compromising overall classification performance.

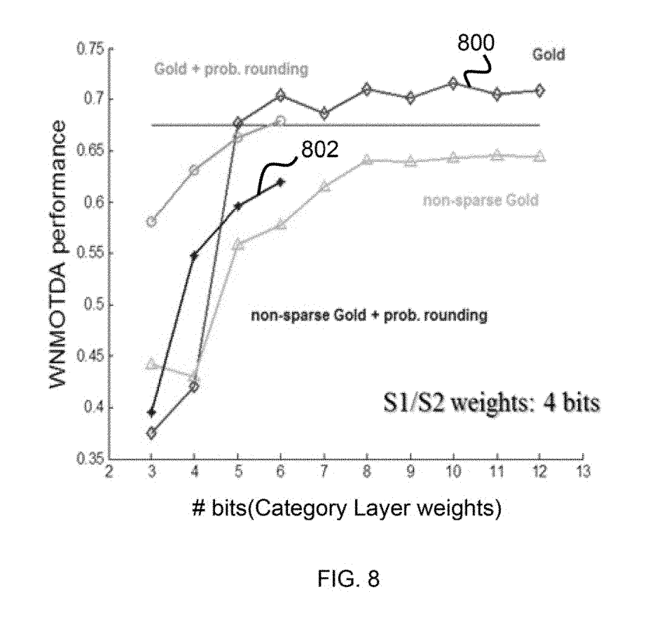

FIG. 8 shows the effects of these various aspects of CNN on performance with respect to the test set. Simulation results clearly demonstrate that Gold CNN 800, which is driven by the invention as including the sparse inference modules, outperforms conventional CNN 802 (i.e., without sparse inference modules) by about 50% in terms of the WNMOTDA score at very low numerical precision (namely, 3 or 4 bits) with probabilistic rounding.

Finally, while this invention has been described in terms of several embodiments, one of ordinary skill in the art will readily recognize that the invention may have other applications in other environments. It should be noted that many embodiments and implementations are possible. Further, the following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”. Further, while particular method steps have been recited in a particular order, the method steps may occur in any desired order and fall within the scope of the present invention.

What is claimed is:

1. A sparse inference module for deep learning, the sparse inference module comprising:
one or more processors and a memory, the memory have executable instructions encoded thereon, such that upon execution, the one or more processors perform operations of:
receiving data and matching the data against a plurality of pattern templates to generate a degree of match value for each of the pattern templates;
sparsifying the degree of match values such that only those degree of match values that satisfy a criterion are provided for further processing as sparse feature vectors, while other losing degree of match values are quenched to zero; and
using the sparse feature vectors to self-select a channel that participates in high-level classification.

2. The sparse inference module for deep learning of claim 1, wherein the data comprises at least one of still image information, video information, and audio information,

3. The sparse inference module for deep learning of claim 1, wherein self-selection of the channel facilitates classification of at least one of still image information, video information, and audio information.

4. The sparse inference module for deep learning of claim 1, wherein the criterion requires the degree of match value to be above a threshold limit.

5. The sparse inference module for deep learning of claim 1, wherein the criterion requires the degree of match value to be within a fixed quantity of the top degree of match values.

6. A computer program product for sparse inference for deep learning, the computer program product comprising:
a non-transitory computer-readable medium having executable instructions encoded thereon, such that upon execution of the instructions by one or more processors, the one or more processors perform operations of:
receiving data and matching the data against a plurality of pattern templates to generate a degree of match value for each of the pattern templates;
sparsifying the degree of match values such that only those degree of match values that satisfy a criterion are provided for further processing as sparse feature vectors, while other losing degree of match values are quenched to zero; and
using the sparse feature vectors to self-select a channel that participates in high-level classification.

7. The computer program product of claim 6, wherein the data comprises at least one of still image information, video information, and audio information.

8. The computer program product of claim 6, wherein self-selection of the channel facilitates classification of at least one of still image information, video information, and audio information.

9. The computer program product of claim 6, wherein the criterion requires the degree of match value to he above a threshold limit.

10. The computer program product of claim 6, wherein the criterion requires the degree of match value to be within a fixed quantity of the top degree of match values.

11. A method for sparse inference for deep learning, the method comprising an act of:
causing one or more processers to execute instructions encoded on a non-transitory computer-readable medium, such that upon execution, the one or more processors perform operations of:
receiving data and matching the data against a plurality of pattern templates to generate a degree of match value for each of the pattern templates;
sparsifying the degree of match values such that only those degree of match values that satisfy a criterion are provided for further processing as sparse feature vectors, while other losing degree of match values are quenched to zero; and
using the sparse feature vectors to self-select a channel that participates in high-level classification.

12. The, method of claim 11, wherein the data comprises at least one of still image information, video information, and audio information.

13. The method of claim 11, wherein self-selection of the channel facilitates classification of at least one of still image information, video information, and audio information.

14. The method of claim 11, wherein the criterion requires the degree of match value to be above a threshold limit.

15. The method of claim 11, wherein the criterion requires the degree of match value to be within a fixed quantity of the top degree of match values.

16. A deep learning system using sparse learning modules, the deep learning system comprising:
a plurality of hierarchical feature channel layers, each feature channel layer having a set of filters that filter data received in the feature channel;
a plurality of sparse inference modules, where a sparse inference module resides electronically within each feature channel layer; and
wherein one or more of the sparse inference module is configured receive data and match the data against a plurality of pattern templates to generate a degree of match value for each of the pattern templates, and sparsify the degree of match values such that only those degree of match values that satisfy a criterion are provided for further processing as sparse feature vectors, while other losing degree of match values are quenched to zero, and use the sparse feature vectors to self-select a channel that participates in high-level classification.

17. The deep learning system as set forth in claim 16, wherein the deep learning system is a convolution neural network (CNN) and the plurality of hierarchical feature channel layers include a first matching layer and a second matching layer, and further comprising:
a first pooling layer electronically positioned between the first and second matching layers; and
a second pooling layer, the second pooling layer positioned downstream from the second matching layer.

18. The deep learning system as set forth in claim 17, wherein the first feature matching layer includes a set of filters, a compressive nonlinearity module, and a sparse inference module.

19. The deep learning system as set forth in claim 17, wherein the second feature matching layer includes a set of filters, a compressive nonlinearity module, and a sparse inference module.

20. The deep learning system as set forth in claim 17, wherein the first pooling layer includes a pooling module and, a sparse inference module.

21. The deep learning system as set forth in claim 17, wherein the second pooling layer includes a pooling module and a sparse inference module.

22. The deep learning system as set forth in claim 16, wherein the sparse learning modules further operate across spatial locations in each of the feature channel layers.
